(19) United States
(12) Patent Application Publication
(10) Pub. No.: US 2011/0010230 A1
(43) Pub. Date: Jan. 13, 2011

(54) METHODS AND SYSTEMS FOR ORGANIZING COMMUNITY SERVICE PARTICIPATION AND CREATING OBJECTIVE RECORDS OF SUCH PARTICIPATION

(75) Inventor: Marco Aurelio Moreira, Boston, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: People Helper, Inc., Boston, MA (US)

(21) Appl. No.: 12/500,193

(22) Filed: Jul. 9, 2009

(51) Int. Cl. G06F 15/16; G06Q 99/00; G06Q 50/00; G06Q 30/00; G06F 17/30

(52) U.S. Cl. 705/14.11; 709/203; 705/34; 707/E17.009; 705/320

(57) ABSTRACT

Methods of and systems for generating on a server computer system an objectively verified record of participation by a helper in one or more community-service-based causes are disclosed. Related computer program products are also disclosed.

### BACKGROUND

The present application relates generally to organizing participation in community service projects, and to generating objectively verified records of such participation.

Students and others often participate in community service projects. Such a participant may wish to describe this participation to others, for instance in the process of applying for admission to a university, or applying for a job. The present application is directed to systems and methods for organizing and making a record of such participation so that the record can be used to describe participation to others in an objective manner. Related computer programs and computer program products are also disclosed. In particular, the systems and methods may be implemented in a computer network such as the internet.

### BRIEF SUMMARY OF EMBODIMENTS OF THE INVENTION

In accordance with one or more embodiments, a method is provided of generating on a server computer system an objectively verified record of participation by a helper in one or more community-service-based causes. The method includes the steps of: storing data at the server computer system identifying a plurality of causes and at least one officer associated with each of said causes; receiving at the server computer system a request from the helper to be associated with a selected one of the causes; receiving at the server computer system one or more reports from the helper indicating said helper's participation in said selected cause; receiving at the server computer system one or more verifications by an officer associated with the selected cause of the one or more reports indicating said helper's participation in said selected cause; adding said one or more reports and said one or more verifications to a record of participation for said helper; storing said record on the server computer system; and making a version of said record available to a party desiring information about said helper.

In accordance with one or more embodiments of the invention, system is provided for generating an objectively verified record of participation by a helper in one or more community-service-based causes. The system comprises a Web server communicating with a plurality of client devices over a network. The Web server is adapted to: store data identifying a plurality of causes and at least one officer associated with each of said causes; receive a request from the helper to be associated with a selected one of the causes; receive one or more reports from the helper indicating said helper's participation in said selected cause; receive one or more verifications by an officer associated with the selected cause of the one or more reports indicating said helper's participation in said selected cause; add said one or more reports and said one or more verifications to a record of participation for said helper; store said record; and make a version of said record available to a party desiring information about said helper.

In accordance with one or more embodiments of the invention, a computer program product is provided. The computer program product comprises a computer usable medium having a computer readable program code embodied therein. The computer readable program code is adapted to be executed to implement a method for generating an objectively verified record of participation by a helper in one or more community-service-based causes. The method comprises: storing data at the server computer system identifying a plurality of causes and at least one officer associated with each of said causes; receiving at the server computer system a request from the helper to be associated with a selected one of the causes; receiving at the server computer system one or more reports from the helper indicating said helper's participation in said selected cause; receiving at the server computer system one or more verifications by an officer associated with the selected cause of the one or more reports indicating said helper's participation in said selected cause; adding said one or more reports and said one or more verifications to a record of participation for said helper; storing said record on the server computer system; and making a version of said record available to a party desiring information about said helper.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a schematic block diagram of a community service participation system in accordance with one or more embodiments of the invention.

FIG. 2 is a flowchart illustrating a community service participation method in accordance with one or more embodiments of the invention.

FIG. 3 is an exemplary screenshot displaying a helper's currently selected causes and searchable listings of further causes in accordance with one or more embodiments of the invention.

FIG. 4A is an exemplary screenshot of a webpage displaying information associated with a particular cause in accordance with one or more embodiments of the invention.

FIG. 4B is an exemplary screenshot displaying a process for inputting information on participation in a cause in accordance with one or more embodiments of the invention.

FIG. 5A is an exemplary screenshot of a webpage displaying information associated with the same cause shown in FIG. 4A with the calendar tab selected in accordance with one or more embodiments of the invention.

FIG. 5B is an exemplary screenshot displaying an interface for inputting information about a calendar event associated with a particular cause in accordance with one or more embodiments of the invention.

FIG. 6A is an exemplary screenshot of a webpage displaying an interface available to an officer in accordance with one or more embodiments of the invention.

FIG. 6B is an exemplary screenshot displaying an interface for an officer to approve, edit, or reject an event submitted by a helper in accordance with one or more embodiments of the invention.

FIG. 6C is an exemplary screenshot displaying an interface for an officer to approve, edit, or reject a task submitted by a helper in accordance with one or more embodiments of the invention.

FIG. 7 is an exemplary screenshot displaying a report of a helper's verified edited record, called a “helper portfolio,” in accordance with one or more embodiments of the invention.

### DETAILED DESCRIPTION

Various embodiments of the systems and methods disclosed herein are directed to promoting community service. In accordance with one or more embodiments, the systems and methods allow a prospective participant, called a “helper”, to learn about the existence of one or more causes in which the helper might wish to participate; and offer the helper the ability to create an objectively verified record of his participation so that others, for example, employers or educational institutions, can more easily recognize and obtain verification of the helper's participation.

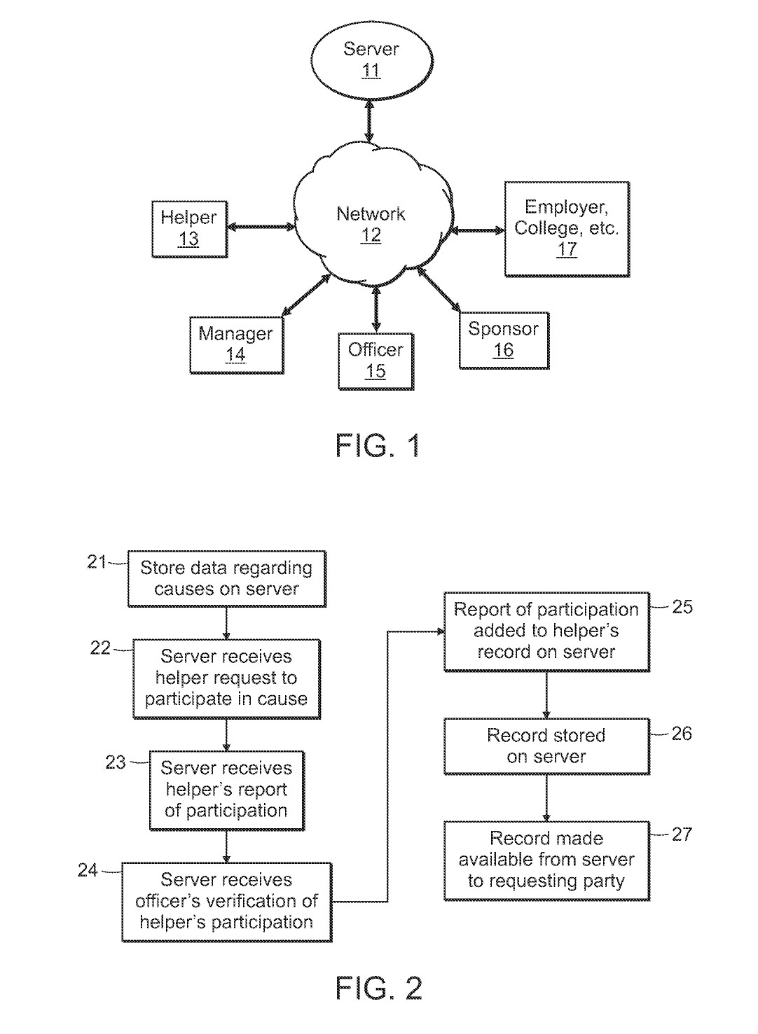

FIG. 1 illustrates a community service participation system in accordance with one or more embodiments of the invention. The figure illustrates some of the relationships between the various parties involved, including a helper 13, an officer 15, a manager 14, a sponsor 16, and a third party 17 to whom a record of participation is to be disclosed, for example, an employer or educational institution. Each of the parties uses a client device to communicate with other parties and/or a server computer system 11 over a network 12.

The network 12 may for example, be the Internet, an intranet, or other communications network. In the case of the Internet, the server 11 can comprise a Web server accessible by the client devices operated by the various parties. The client devices may, for example, be a personal computer such as a Pentium®-based desktop or notebook computer running a Windows® operating system. Alternatively, the client devices may be portable communication devices such as a personal digital assistant (PDA) or a cellular telephone. The client devices can include a variety of conventional browsers, such as, for example, Microsoft Internet Explorer® or Mozilla Firefox® Web browsers.

In one or more embodiments, information about the different causes available to a helper 13 is stored on a server 11. The server 11 makes it possible for a helper 13 to access the data through a network 12. In this way a helper 13 may investigate what causes are currently in need of helpers, and a helper 13 may also upload to the server 11 any number of reports on his participation in a cause.

The “causes” cataloged on the server 11 may be highly varied and not limited to organizations in any one particular geographical community or topic. Organizations could include, for example, charities, political advocacy groups, educational institutions, and medical institutions.

Another party involved in the disclosed methods and systems is the officer 15. An officer is a person associated with a cause, who will serve to verify a helper's participation. It is possible for an officer 15 associated with a particular cause or causes to interact with the server 11 through the network 12. In this way the officer 15 can review accept, edit, and/or reject reports of helpers' participation in a cause with which the officer 15 is associated. The officer's acceptance, rejection, and/or edits are then recorded on the server 11. It may also possible for the officer 15 to commend helpers for their participation with such commendations being entered in a record stored on the server 11.

A third party 17 also interacts with the server 11 through the network 12. A record associated with a particular helper 13 can be made available to an interested third party 17 through the server. The third party 17 might be an educational or other institution at which the helper 13 is attempting to complete a community service requirement, or the third party 17 could be considering the helper's verified record of service in the context of an application by the helper 13, for instance for employment, matriculation, or membership.

Other parties may also interact with the server 11 in various embodiments. In some embodiments, each cause has a manager 14 associated with it. The manager 14 may simply be a designated helper who has volunteered to organize support for the cause, or the manager 14 may be some other responsible individual. In one or more embodiments, a sponsor 16 may choose to be associated with the system generally, or with one or more causes. The sponsor's role could include advertising on the server 11, contributing to one or more causes, and/or contributing rewards to be distributed to helpers 13 who participate in one or more causes.

FIG. 2 is a flowchart showing the steps of a community service participation method in accordance with one or more embodiments of the invention.

The first step 21 of the method involves storing data on the server 11. The data will identify one or more causes, as well as the name of one or more officers 15 associated with each cause. The data could contain additional information as well, for instance the identities of sponsors or managers 14 if they exist.

In the next step 22, the server 11 receives a request from a helper 13 to be associated with one or more causes.

In the next step 23, the server receives one or more reports of the helper's participation. The report may include a description of the dates and times of the helper's participation, and/or a description of the activities in which the helper 13 participated.

In the next step 24, the server receives from an officer 15 associated with the cause a verification of the report in the form of an acceptance, rejection, or edit of the report.

In the next step 25, the verified report is added to a record associated with the helper 13. In one or more embodiments, further additions are made to the record at this stage, the additions possibly including commendations of the helper 13, awards, and/or scholarships the helper 13 has won, contact information for those acting as references on the helper's behalf, testimonials about the helper 13, and/or anything else the helper 13 would wish to communicate to a party reviewing his record.

In the next step 26, a version of the record is stored on the server.

In the next step 27, the record is made available to a third party. The version made available could be a complete record of all verified reports, or could be an edited version. If the version made available is an edited version, the edits could be specific to the particular party receiving the report. The edits may be defined by the helper 13.

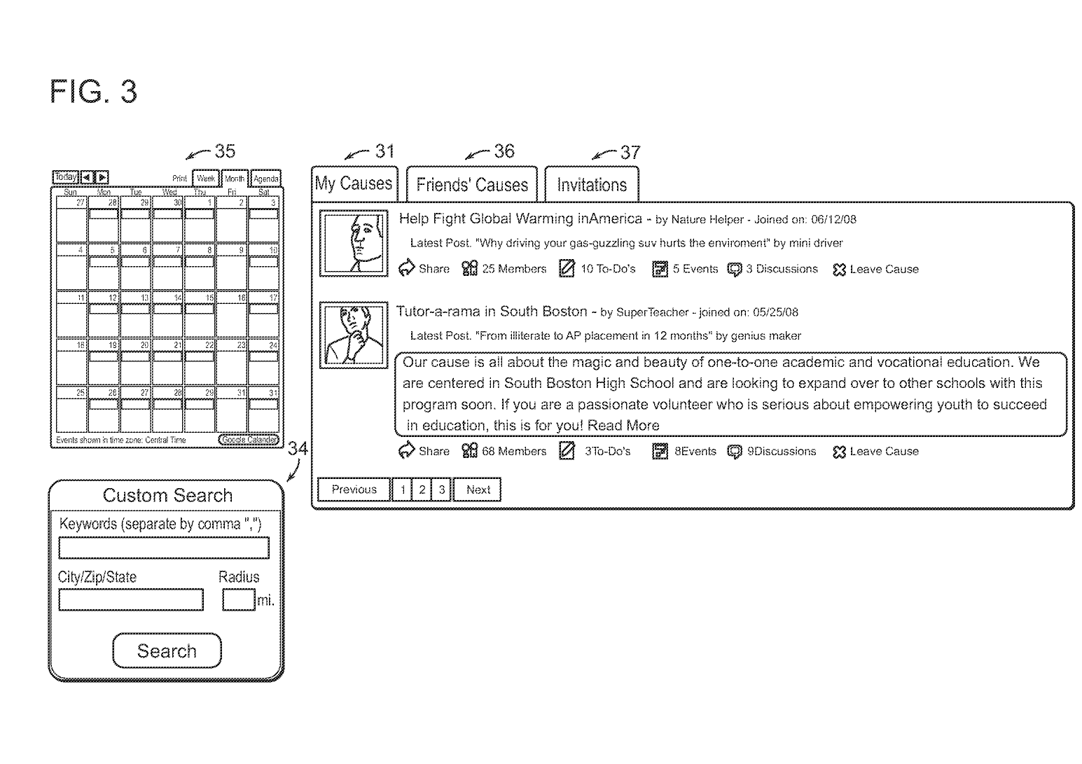

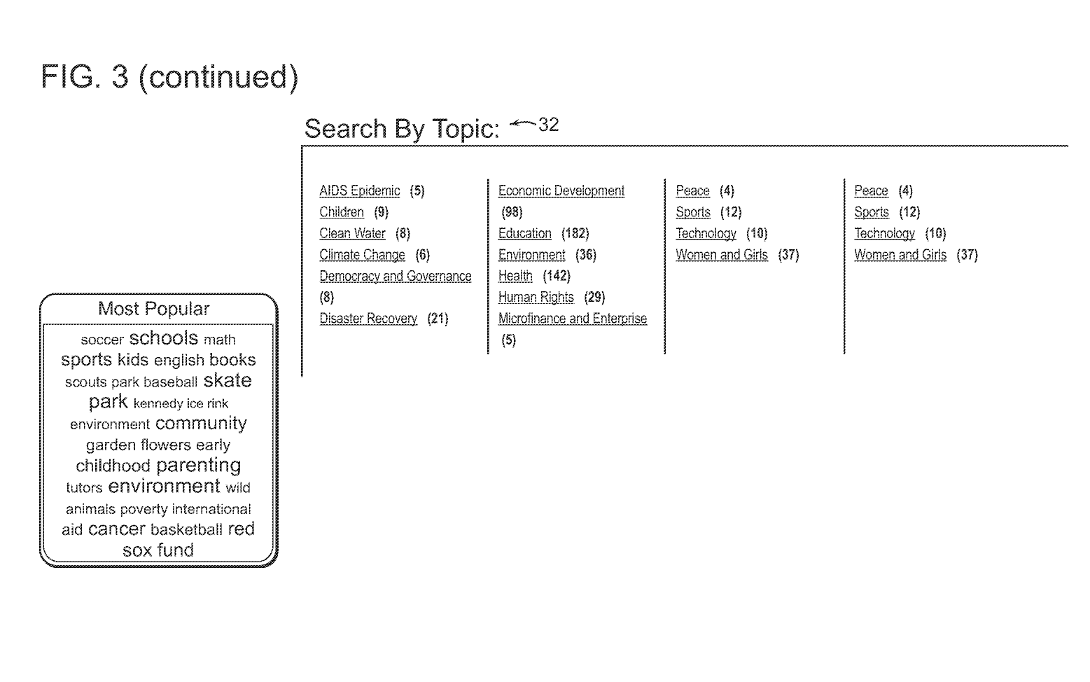

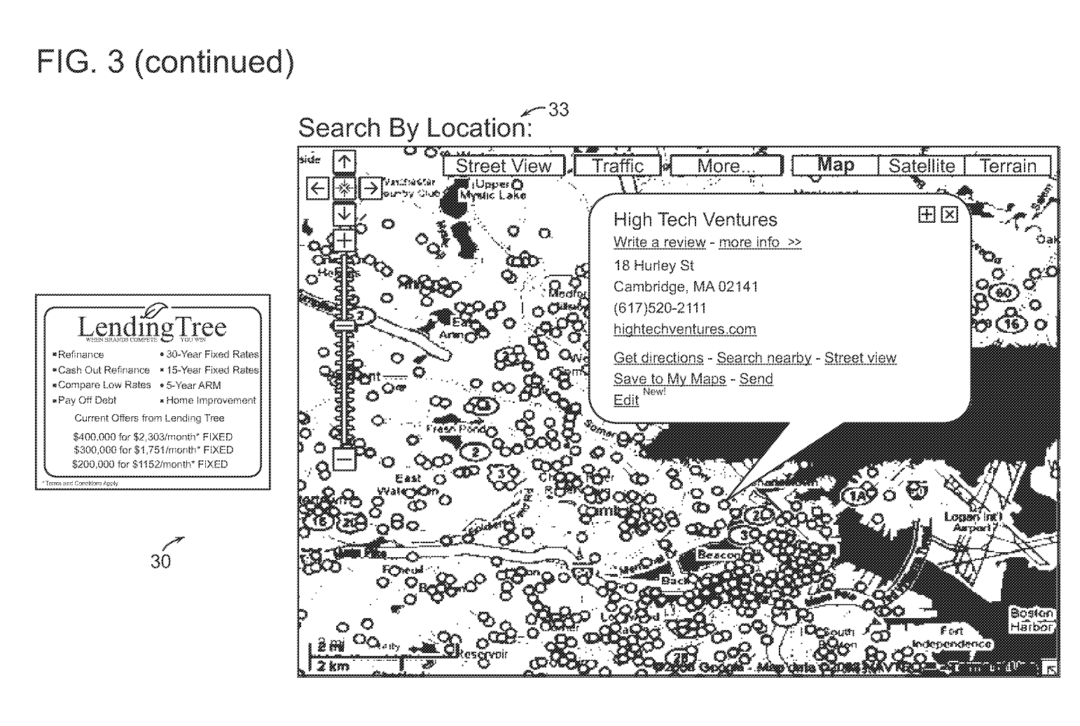

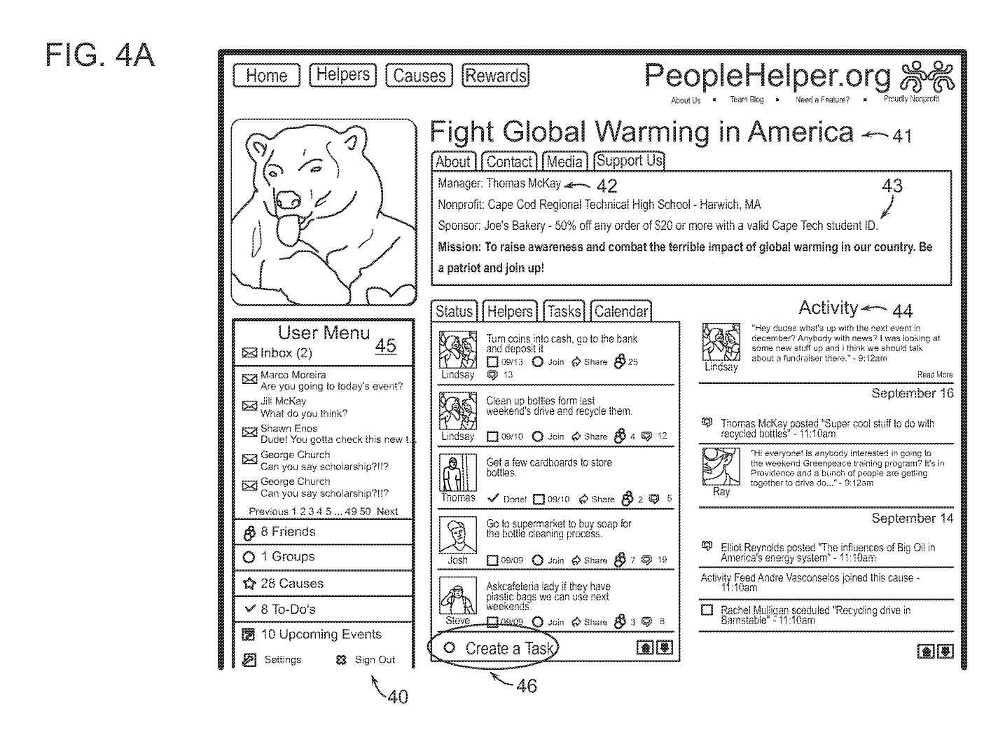

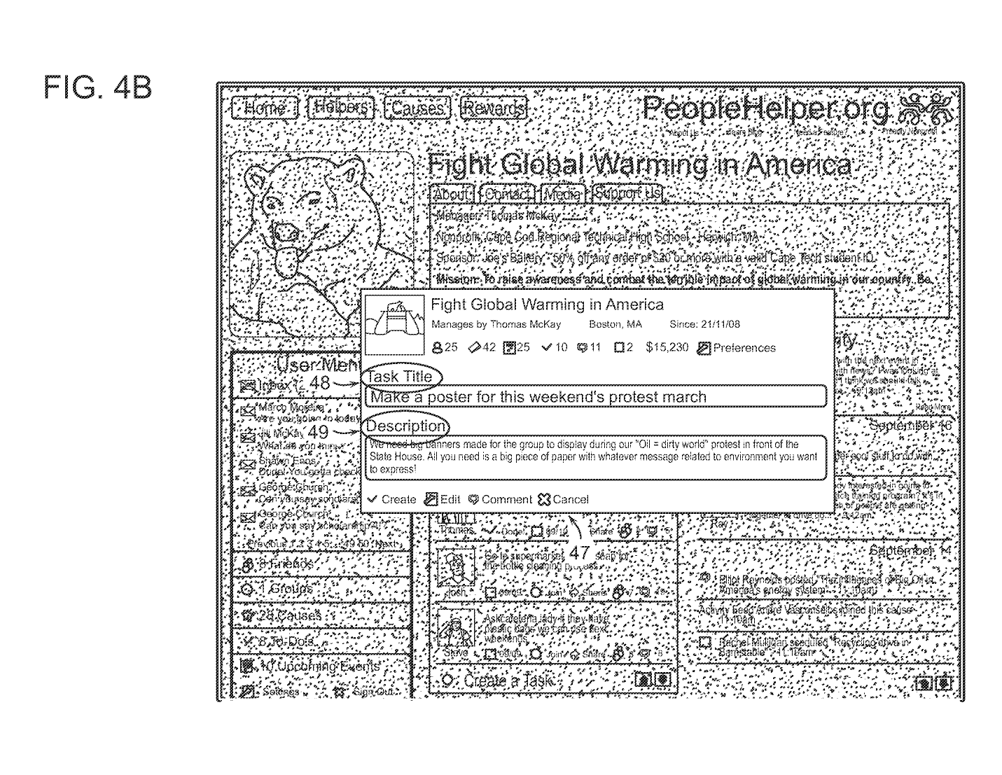

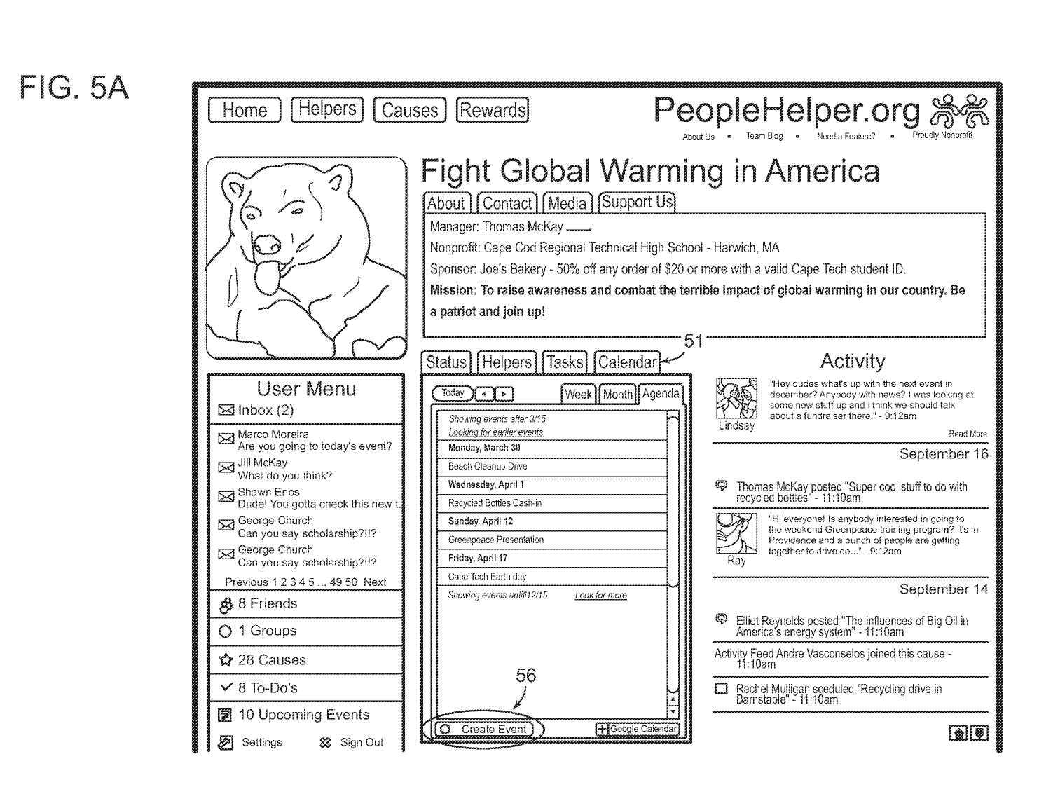

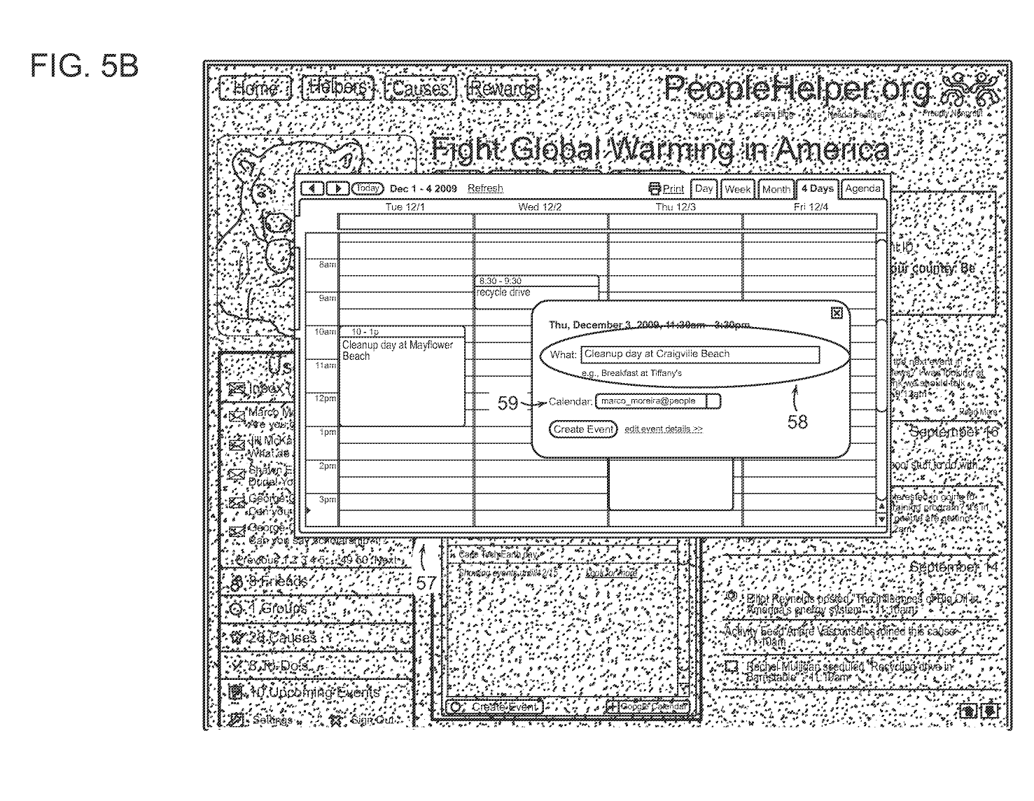

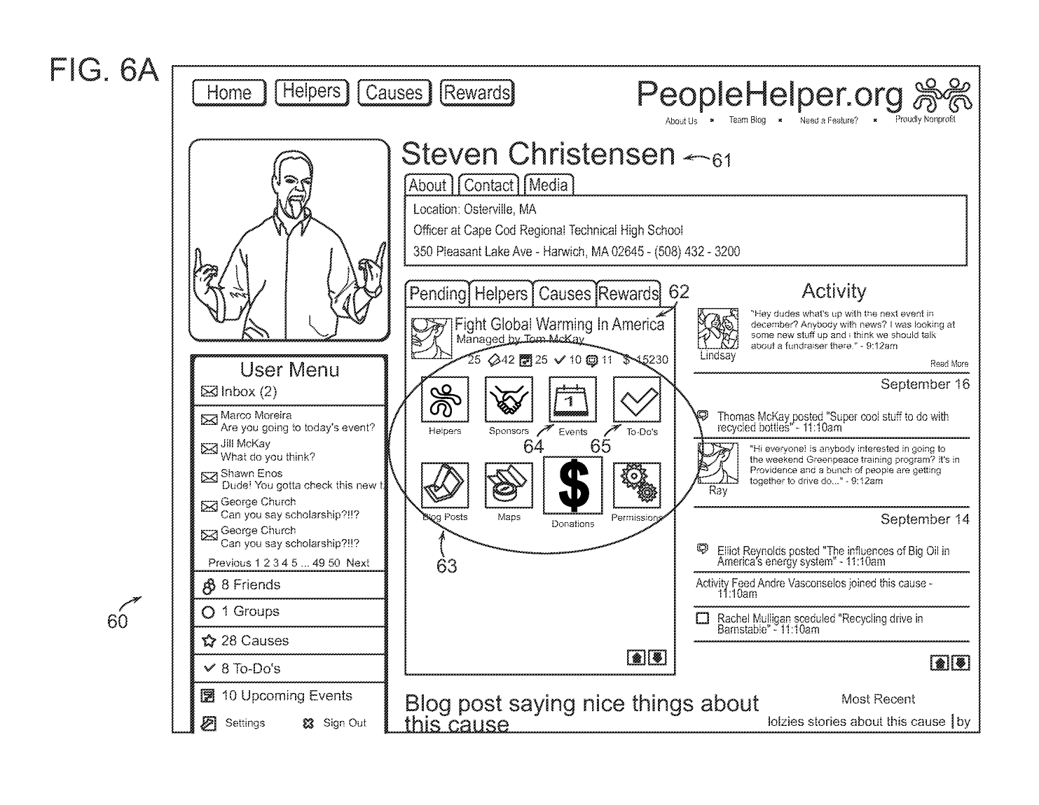

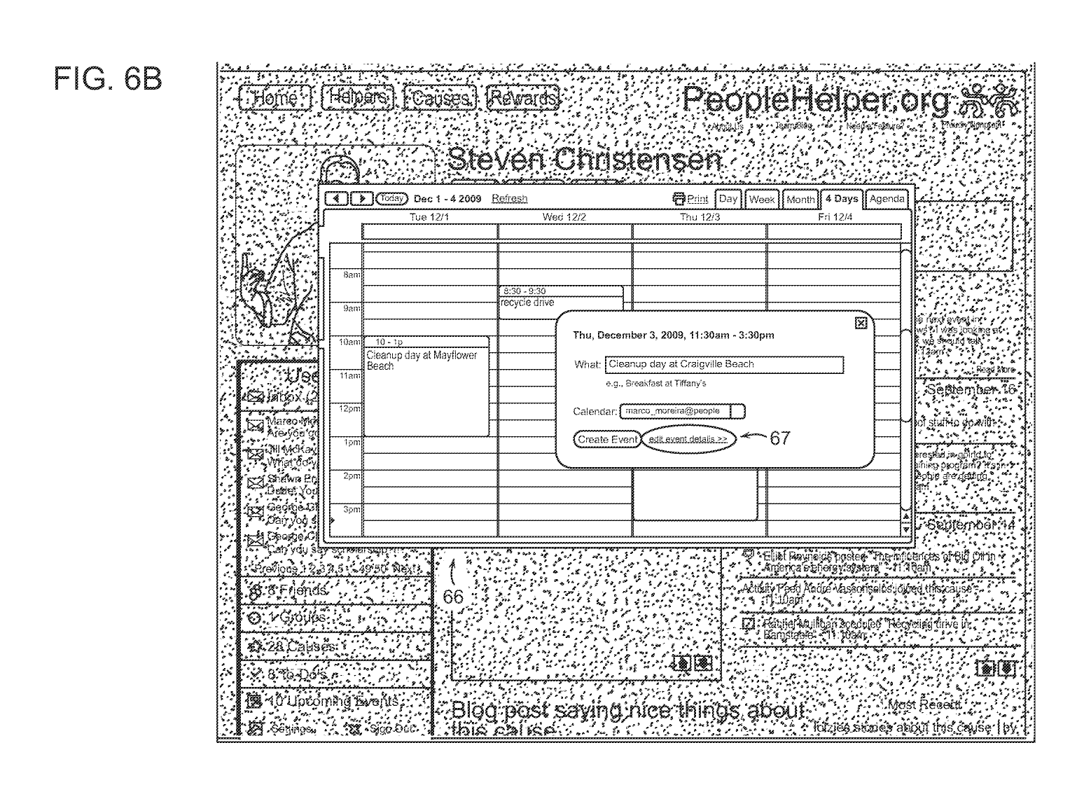

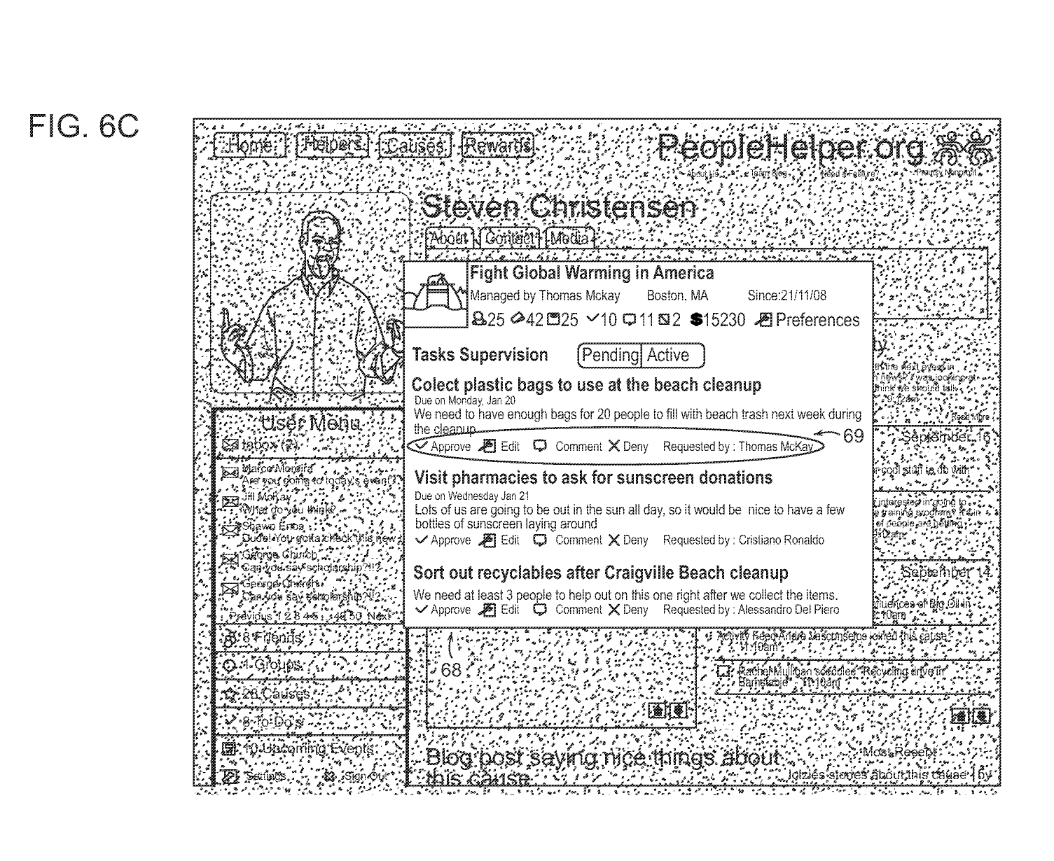

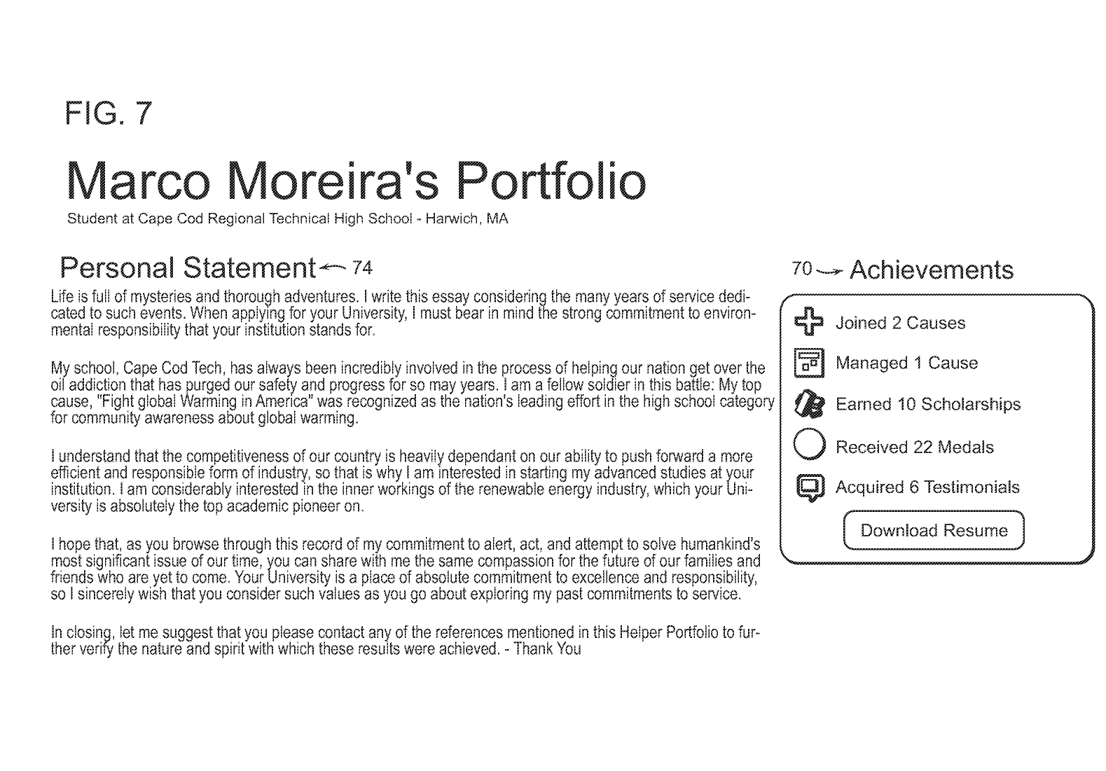

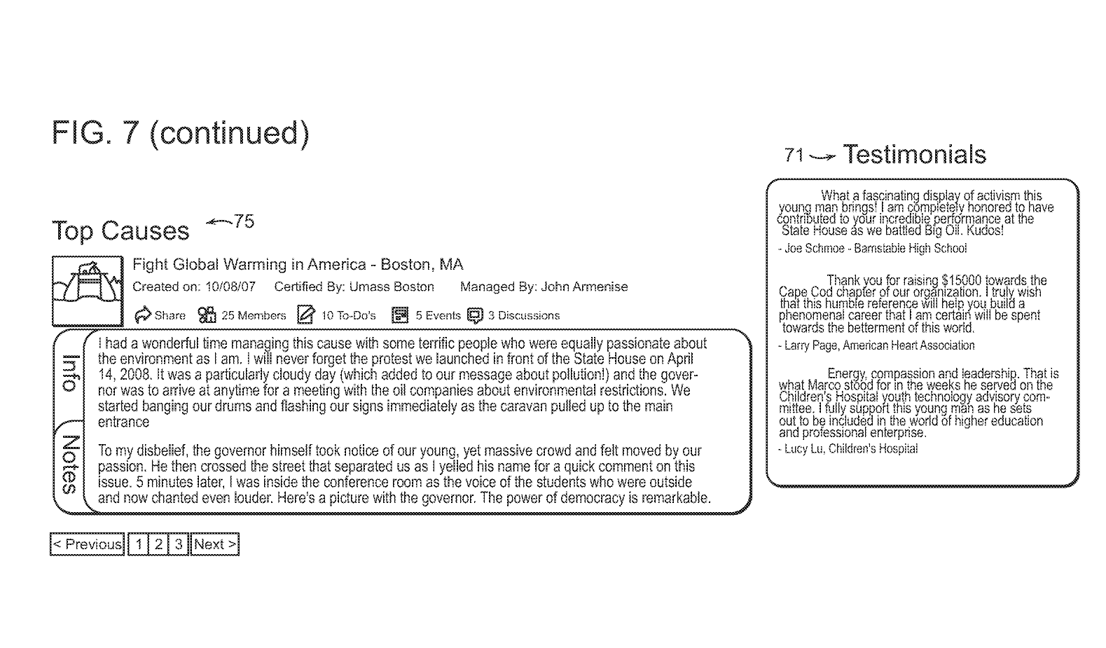

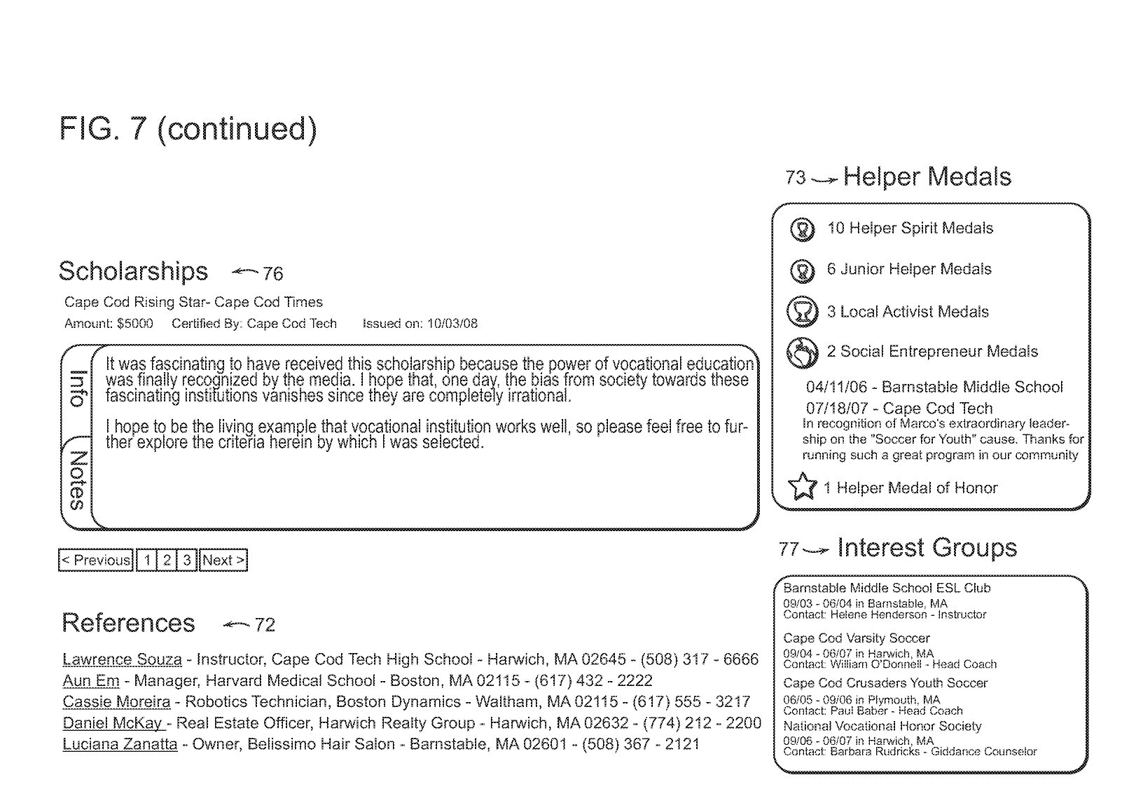

FIGS. 3-7 are exemplary screen shots illustrating operation of the community service participation system in accordance with one or more embodiments of the invention. FIG. 3 shows how the helper 13 can choose a cause and organize his participation in multiple causes. FIGS. 4A and B show one way the helper 13 can submit a report of his participation in a cause through the network. FIGS. 5A and B show how an alternative way the helper 13 can submit a report of his participation in a cause. FIGS. 6A-C show how an officer 15 can review, accept, edit, or reject a helper's reports of participation in the cause. FIG. 7 shows an example of how the reviewed and approved data describing the helper's participation can be displayed.

FIG. 3 is an exemplary screenshot displaying a helper's currently selected causes and searchable listings of further causes in accordance with one or more embodiments of the invention. The screenshot 30 shows an example of an interface that can be displayed to a helper 13 when accessing the server in a particular embodiment. The interface can include a section listing causes with which the helper 13 is associated, in this embodiment labeled “my causes” 31. The interface could further list a variety of categories 32 of causes stored on the server. This particular embodiment also displays geographical locations 33 associated with each cause and allows the helper 13 to search for cause geographically. This embodiment also allows searching by keywords associated with causes in section 34. This embodiment also displays a calendar of events 35 associated with the helper's chosen causes. In this embodiment, online social networking has been integrated into the system. In addition to displaying the helper's own causes 31, the screenshot shows that the helper 13 can view causes selected by his friends at tab 36, or invitations for the helper 13 to join other causes at tab 37.

FIG. 4A is an exemplary screenshot of a cause webpage 40 displaying information associated with a particular cause 41, in this example “Fight Global Warming in America,” in accordance with one or more embodiments of the invention. Information listed on the cause webpage 40 can include the identity of a manager at 42, and/or a sponsor at 43. The integration of social networking technology can be seen in the “activity” section 44 and in the listing of helpers 13 associated with the cause in the “user menu” 45, both of which provide the viewer with information on how others are participating in this and other causes. The cause webpage 40 also allows the user-helper 13 to input information about his or her participation in the cause by selecting the “create a task” option 46. The results of creating a task are shown in FIG. 4B.

FIG. 4B is an exemplary screenshot displaying an interface 47 for allowing a user-helper 13 to input information on participation in a cause in accordance with one or more embodiments of the invention. In this embodiment, after selecting the “create a task” option 46 as shown in FIG. 4A, the user-helper 13 can input information such as a title 48 and description 49 for the task. A user might also be prompted to enter other information. The information is then stored on the server.

FIG. 5A is an exemplary screenshot of a webpage 50 displaying information associated with the same cause shown in FIG. 4A, but in this case the calendar tab 51 is selected to show a list of scheduled events associated with the cause. The webpage is similar to that shown in FIG. 4A, but when the calendar display mode is selected as shown, the user-helper 13 has the option of choosing to “create an event” 56 instead of creating a task as shown in FIG. 4A.

FIG. 5B is an exemplary screenshot displaying an interface for inputting information about a calendar event associated with a particular cause. Selecting the “create event” option 56, shown in FIG. 5A, causes this embodiment to display a calendar-based interface 57 for inputting information about an event associated with the cause. The inputted information may include a description of the activities performed or to be performed 58, a particular calendar on which the event should be posted 59, and the time, length, or location of the event. In some embodiments, although a helper 13 is able to create tasks (as in FIGS. 4A and B) or events (as in FIGS. 5A and B), these will not become visible to others until a moderator, such as an officer 15 or manager 14, has approved the task or event.

FIG. 6A is an exemplary screenshot of a webpage 60 displaying an interface 61 displayed to an officer 15, in this example “Steve Christensen”, in accordance with one or more embodiments of the invention. In this case, the cause with which the officer 15 is associated is the same cause shown in FIGS. 4A and B and 5A and B, “Fight Global Warming in America” 62. The officer can moderate a variety of on-line postings 63 associated with the cause, such as tasks 65 posted by helpers 13 as shown in FIGS. 4A and B, or events 64 posted by helpers as shown in FIGS. 5A and B.

FIG. 6B is an exemplary screenshot displaying an interface for an officer 15 to approve, edit, or reject an event submitted by a helper 13. After selecting the option to edit events 64 as shown in FIG. 6A, the officer 15 may be presented with a calendar-based interface 66 similar to the calendar-based interface 57 presented to helpers 13 shown in FIG. 5B. This interface 66 gives the officer an option 67 to review events submitted by helpers 13 and decide whether to approve, edit, or reject the events before the event gets displayed publicly on the website or added to the helper's record.

FIG. 6C is an exemplary screenshot displaying an interface for an officer 15 to approve, edit, or reject a task submitted by a helper 13. After selecting the option to edit a task 64 as shown in FIG. 6A, the officer 15 may be presented with an interface 68 for reviewing tasks previously submitted by a helper 13, similar to the interface 47 used by helpers 13 to submit tasks.

FIG. 7 is an exemplary screenshot displaying a report of a helper's verified edited record, called a “helper portfolio,” in accordance with one or more embodiments of the invention. In this particular example, the portfolio includes a summary of the helper's achievements 70, testimonials 71 about the helper 13, a list of references with contact information 72, a listing of “medals” 73 or commendations received by the helper 13 for verified service performed, a personal statement 74 by the helper 13, a listing of the causes with which the helper is associated 75, a listing of scholarships or awards 76 accrued by the helper, and a listing of the helper's other interests 77. The portfolio need not be limited to the information or combination of information shown in this embodiment, and could include more or less detail on any of the subjects shown here. In this example, some fields, such as the helper's personal statement 74 and other interests 77, are entirely under the helper's control and the helper is free to edit them as he or she pleases. Others, such as the summary of achievements 70, are automatically generated and thus are objectively generated by the system. Others, such as the listings of testimonials 71, references 72, medals 73, and associated causes 75, may be partially controlled by the helper 13 in that, while the helper 13 is not allowed to edit the content of these listings, the helper 13 may be able to select some content for display while keeping other content hidden. In some embodiments, the helper 13 may be able to save such edits to more than one version of the helper 13 portfolio, possibly associating the different versions with different viewers. For example, the helper 13 might create one version of the portfolio edited for viewing by colleges to which the helper 13 is applying, and another version of the portfolio edited for viewing by potential employers.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above are preferably implemented in software, and accordingly one of the preferred implementations of the invention is as a set of instructions (program code) in a code module resident in the random access memory of the computer. Until required by the computer, the set of instructions may be stored in another computer memory, e.g., in a hard disk drive, or in a removable memory such as an optical disk (for eventual use in a CD or DVD ROM) or floppy disk (for eventual use in a floppy disk drive), a removable storage device (e.g., external hard drive, memory card, or flash drive), or downloaded via the Internet or some other computer network. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

What is claimed is:

1. A method of generating on a server computer system an objectively verified record of participation by a helper in one or more community-service-based causes, the method comprising:
storing data at the server computer system identifying a plurality of causes and at least one officer associated with each of said causes;
receiving at the server computer system a request from the helper to be associated with a selected one of the causes;
receiving at the server computer system one or more reports from the helper indicating said helper's participation in said selected cause;
receiving at the server computer system one or more verifications by an officer associated with the selected cause of the one or more reports indicating said helper's participation in said selected cause;
adding said one or more reports and said one or more verifications to a record of participation for said helper;
storing said record on the server computer system; and
making a version of said record available to a party desiring information about said helper.

2. The method of claim 1 wherein the cause is directed to aiding one or more community service organizations.

3. The method of claim 1 wherein the officer is an employee of a community service organization or an educational institution in which said helper is a student.

4. The method of claim 1 further comprising the step of charging a fee to the helper for making a version of said record available to a party desiring information about said helper.

5. The method of claim 1 further comprising the step of charging a fee to the party to view the record.

6. The method of claim 1 wherein the party is an educational institution to which the helper has submitted an application for admission.

7. The method of claim 1 wherein the party is an employer to which the helper has applied for employment.

8. The method of claim 1 further comprising the step of receiving at the server computer system a commendation to the helper for his or her participation in said selected cause.

9. The method of claim 1 further comprising the step of receiving on the server computer system a request from a sponsor to associate itself with one or more causes.

10. The method of claim 1 further comprising the step of adding to the record contact information for said officer.

11. The method of claim 1 further comprising the step of associating a reward with said record.

12. The method of claim 11 further comprising the step of distributing the reward to the helper.

13. The method of claim 11 wherein the reward is provided by a sponsor associated with said cause.

14. The method of claim 1 wherein said helper, said officer, and said party operate client devices that communicate with the server computer system over a computer network.

15. The method of claim 14 wherein said server computer system comprises a Web server and said computer network comprises the Internet.

16. The method of claim 1 further comprising receiving at the server computer system instructions from the helper to create an edited version of said record, wherein the version made available to the party is the edited version.

17. A system for generating an objectively verified record of participation by a helper in one or more community-service-based causes comprising a Web server communicating with a plurality of client devices over a network, the Web server being adapted to: store data identifying a plurality of causes and at least one officer associated with each of said causes; receive a request from the helper to be associated with a selected one of the causes; receive one or more reports from the helper indicating said helper's participation in said selected cause; receive one or more verifications by an officer associated with the selected cause of the one or more reports indicating said helper's participation in said selected cause; add said one or more reports and said one or more verifications to a record of participation for said helper; store said record; and make a version of said record available to a party desiring information about said helper.

18. A computer program product, comprising a computer usable medium having a computer readable program code embodied therein, said computer readable program code adapted to be executed to implement a method for generating an objectively verified record of participation by a helper in one or more community-service-based causes, the method comprising:
storing data at the server computer system identifying a plurality of causes and at least one officer associated with each of said causes;
receiving at the server computer system a request from the helper to be associated with a selected one of the causes;
receiving at the server computer system one or more reports from the helper indicating said helper's participation in said selected cause;
receiving at the server computer system one or more verifications by an officer associated with the selected cause of the one or more reports indicating said helper's participation in said selected cause;
adding said one or more reports and said one or more verifications to a record of participation for said helper;
storing said record on the server computer system; and
making a version of said record available to a party desiring information about said helper.
